(19) United States
(12) Patent Application Publication
(10) Pub. No.: US 2019/0302987 A1
(43) Pub. Date: Oct. 3, 2019

(54) DATA VISUALIZATION USING AN IMMERSIVE CLOUD ENVIRONMENT

(71) Applicant: LOCKHEED MARTIN CORPORATION, Bethesda, MD (US)

(72) Inventors: Joseph Michael Worsham, Bethesda, MD (US); Calvin Pinsuwan, Bethesda, MD (US); Thomas Michael Rogers, Bethesda, MD (US); Steven J. Schifris, Bethesda, MD (US); Makenna Grace Fish, Bethesda, MD (US)

(21) Appl. No.: 15/941,881

(22) Filed: Mar. 30, 2018

(51) Int. Cl. G06F 3/0481; G06F 3/0482; G06T 11/60; G06T 19/00

(52) U.S. Cl. CPC G06F 3/04815; G06F 3/0482; G06T 2200/24; G06T 19/006; G06T 11/60

(57) ABSTRACT

The formation of a 3D Immersive Cloud Environment (ICE) that can be displayed to a user to form a user interface where the data is easy to understand and interact with by the user. The techniques described herein take a large number of discrete data elements and generates the ICE from the discrete data elements by determining a relative layout placement of the discrete data elements and determining a spherical layout positioning of the discrete data elements. The ICE is then displayed to the user. The techniques described herein permit the efficient display of large amounts of data in an interactive user interface utilizing some or the entire Field of Regard (FoR) rendering space that is available around the user. The displayed data may maintain a relative order, does not require complex hierarchies, and can include spatial cues to efficiently convey information to the user.

### FIELD

This disclosure relates to data visualization, in particular to generating and displaying a large amount of data in a three-dimensional (3D), easy-to-understand user interface around a user.

### BACKGROUND

The availability of large amounts of data in all industries is well understood. Data is often arranged and presented to the user in a hierarchical fashion where “drill-downs” are used by the user to eventually reach the desired entry. For example, the data may be A-Z indexed, with the user required to continually “drill-down” through selected indexed data entries to find the desired data. Many conventional approaches that are used require some amount of training and can take significant time to find the desired data.

The field of data visualization has made strides in the use of immersive technologies such as virtual reality (VR) and augmented reality (AR) to display data to users. Many of the known VR/AR solutions focus on rendering high-dimensional data in 3D space. Other VR/AR solutions have focused on building platforms for immersive data visualization which work on very simple axis-oriented alignments.

One known technique for data visualization is called Wordle™ which generates two dimensional “word clouds” out of non-uniformly sized text samples. The word clouds give greater prominence to words that appear more frequently in the source text. Further information on Wordle can be found at www.wordle.net.

### SUMMARY

Techniques are described where a user is immersed in a generated 3D data cloud forming an interactive user interface where the data is easy to understand and interact with by the user. The 3D data cloud may be referred to as an 3D Immersive Cloud Environment (ICE). The techniques described herein permit the efficient display of large amounts of data in an interactive user interface utilizing some or the entire Field of Regard (FoR) rendering space that is available around the user. The displayed data may maintain a relative order, does not require complex hierarchies, and can include spatial cues to efficiently convey information to the user. A spatial cue, if used, can be any form of spatial modifier, such as scale or placement of data elements, which can be used to convey additional information. For example, if a set of data elements exists where each data element has a name and some useful metric, such as magnitude, then a scale can be applied to each data element in the ICE to order the data elements alphabetically, but convey magnitude by the size of each data element. In addition, other visual cues in the ICE are possible which can be used to convey additional information regarding the data elements. Examples of visual cues that can be applied to the data elements in the ICE include, but are not limited to, color gradients, patterns, highlighting, and tooltips.

The techniques described herein take a large number of discrete data elements (also referred to as user interface elements), and generates the ICE from the discrete data elements by determining a relative layout placement of the discrete data elements and determining a spherical layout positioning of the discrete data elements. The ICE is then displayed to the user. The described techniques transform the data elements into the 3D ICE that is displayed to the user.

The discrete data elements can be any discrete item/element of data which can be represented as a 2D or 3D user interface element before being rendered in the ICE described herein. Examples of discrete data elements include, but are not limited to, alphabetical text, numeric text, alphanumeric text, images, symbols, other renderable data elements, or combinations thereof. In one embodiment, the discrete data elements can be generally rectangular in shape, each with a width and a height that is needed to place the respective data element in the ICE. The data elements can have non-uniform sizes where each data element can have a different size, or some of the data elements can have a different size compared to other ones of the data elements. However, in some embodiments, the data elements can have the same size.

In the relative layout placement, the data elements can be arranged generally into a plurality of rows and columns. The data elements can have an ordering, where the ordering of the data elements can be substantially maintained when the ICE is generated. The ordering can be ascending or descending, and the ordering can be done alphabetically, numerically, by date, or using any other ordering scheme.

In the spherical layout positioning, the ICE with the data elements forms a quadrangle or a sphere around the user. In one embodiment, the ICE can extend between about 180 degrees to 360 degrees in longitude about the user. In one embodiment, the ICE can extend no more than about 140 degrees in latitude about the user.

A data visualization method of displaying discrete data elements to an end user includes generating a 3D ICE of the discrete data elements, for example using one or more computers. The 3D ICE includes a relative layout placement of the discrete data elements and a spherical layout positioning of the discrete data elements. The generated 3D ICE is then displayed to the end user. In this embodiment, the discrete data elements in the displayed three-dimensional immersive cloud environment do not overlap one another. The end user is able to select any one of the discrete data elements in the displayed 3D ICE whereby when one of the discrete data elements in the displayed 3D ICE is selected additional data related to the selected one of the discrete data elements is displayed to the end user.

In another embodiment, a method includes using one or more computers to generate a 3D ICE from a plurality of discrete, rectangular user interface elements that have a pre-determined ordering by determining a relative layout placement of the rectangular user interface elements followed by determining a spherical layout positioning of the rectangular user interface elements. The relative layout placement of the rectangular user interface elements includes arranging the rectangular user interface elements into a plurality of rows and columns. The 3D ICE is then displayed to an end user, wherein the ordering of the rectangular user interface elements in the displayed 3D ICE is substantially maintained, the rectangular user interface elements in the displayed 3D ICE are displayed in the rows and columns and the rectangular user interface elements do not overlap one another, and wherein at least some of the rectangular user interface elements in the displayed 3D ICE have different sizes compared to other ones of the rectangular user interface elements in the displayed 3D ICE. The end user is able to select any one of the rectangular user interface elements in the displayed 3D ICE whereby when one of the rectangular user interface elements in the displayed 3D ICE is selected additional data related to the selected one of the rectangular user interface elements is displayed.

### DRAWINGS

FIGS. 1A and 1B illustrate an example of an ordered, partial arrangement of data elements that can be used to generate a 3D ICE described herein.

FIG. 2 illustrates an example of anchor points used in determining the relative layout placement of the data elements in the 3D ICE.

FIG. 3 illustrates an example of a sphere and quadrangle used in determining the spherical layout positioning of the data elements in the 3D ICE.

FIG. 4 illustrates an example of a portion of a displayed 3D ICE generated from the data elements in FIGS. 1A-B.

FIG. 5 illustrates an exterior or rear view of the displayed 3D ICE relative to the user who is represented as a dot in front of the displayed 3D ICE.

FIG. 6 is a close-up view of a portion of the displayed 3D ICE of FIG. 4.

FIG. 7 illustrates an example of one of the displayed data elements in the displayed 3D ICE being selected.

FIG. 8 illustrates a system for generating and displaying the 3D ICE.

### DETAILED DESCRIPTION

An Immersive Cloud Environment (ICE) described herein is a 3D User Interface (UI) construct that immerses the user within a large set of discrete data elements. The data elements contained in the ICE is any discrete data element which can be represented as a 2D or 3D UI element before being rendered in the ICE. Each UI construct can be structured in any format which will allow for embedding data elements into clusters which are then laid out in the 3D ICE. In one embodiment, each data element can be generally rectangular with a width and a height that is used to place the data element in the ICE. Examples of discrete data elements include, but are not limited to, alphabetical text, numeric text, alphanumeric text, images, symbols, other renderable data elements, or combinations thereof. The data elements can have non-uniform sizes where each data element can have a different size, or some of the data elements can have a different size compared to other ones of the data elements. However, in some embodiments, the data elements can have the same size.

To generate the ICE, a set of rectangular data elements is laid out in a spherical pattern around some center point such that the order of the data elements is largely maintained and no data elements overlap each other. Additionally, as little space as possible should be consumed by the set of data elements i.e. the data elements should be clustered together instead of being spread out across the imaginary sphere. This is essentially an ordered packing problem where the goal is to fill some space with weighted data elements in which the order of the data elements is maintained at a high-level. The ordering can be done alphabetically, numerically, by date, or using any other ordering scheme. Enforcing the order to be maintained at a high-level is meant to describe the situation in which the exact order of the data elements is not guaranteed, but data elements are still maintained in a relative order in regards to the entire dataset of data elements (for example, the word “apple” could be placed before the word “apply”, but the words “app,” “apple” and “apply” would be located together with the rest of the words starting with “ap”). In this case, the space where the data elements can be placed is defined as a continuous system of Cartesian coordinates (in the form of x, y). These Cartesian coordinates are then projected onto a 3D sphere to create the ICE.

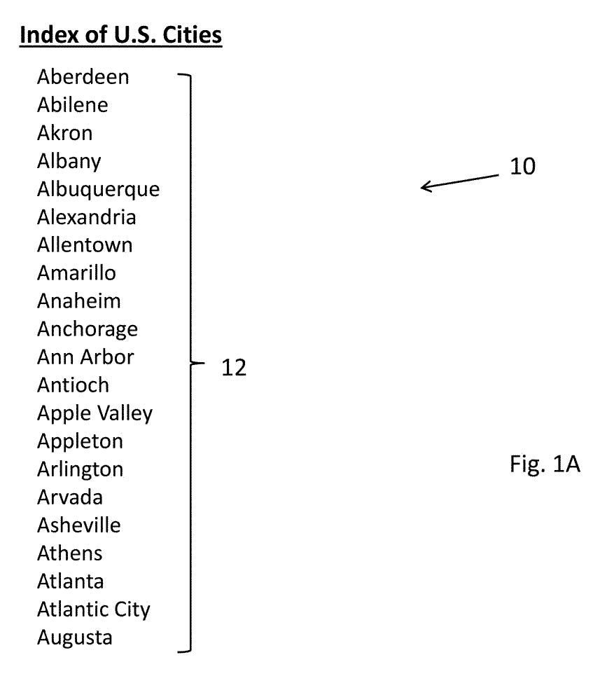

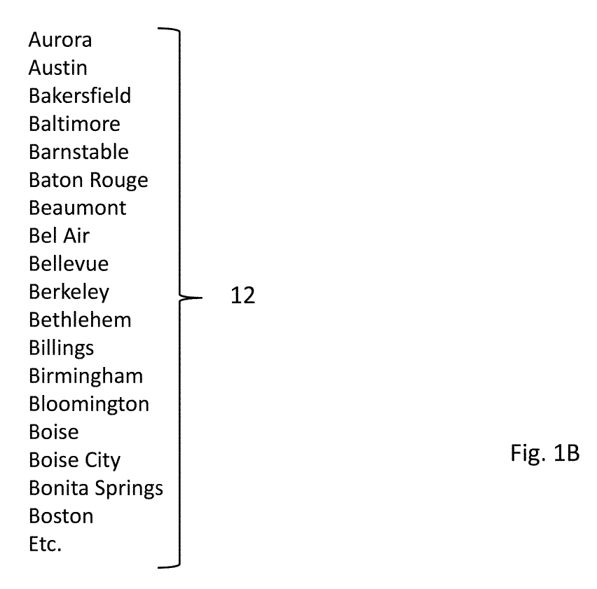

To help describe the concepts disclosed herein, a non-limiting example of an ordered arrangement of data elements from which an ICE described herein can be generated is illustrated in FIGS. 1A-1B. It is to be realized that the data elements in FIGS. 1A-B are an example only, and the ICE described herein can be constructed from other ordered arrangements of data elements. In this example, an ordered list 10 of data elements 12 is depicted with the data elements 12 in this example being various names of U.S. cities and the city names are ordered alphabetically in ascending order. The entire list of city names is not illustrated in FIGS. 1A-B. The city names in FIGS. 1A-B are just some of the city names obtained from www.jordonmeyer.com/text-list-of-us-cities/.

In its original form, the list 10 can be a user interface that is displayable to a user, and each one of the city names can be selected by the user. By selecting one of the city names, the user interface displays a drill down of some information relating to the selected city. For example, if the city name Atlanta is selected, information relating to Atlanta, such as a list of businesses headquartered in Atlanta, can be displayed. If the user selects one of the listed businesses, the user interface can further drill down to display information about the selected business.

To generate a 3D ICE described herein from the city names in FIGS. 1A-B, the city name data elements are processed by determining a relative layout placement of the data elements and determining a spherical layout positioning of the data elements. In one embodiment, the relative layout placement processing occurs before the spherical layout positioning processing. However, it is possible that the relative layout placement processing occurs after the spherical layout positioning processing, or that the relative layout placement processing occurs substantially at the same time as the spherical layout positioning processing.

Relative Layout Placement Processing

The relative layout placement processing is essentially a non-uniform ordered placement problem, where the data elements are not guaranteed to have uniform sizes but the ordering of the data elements must still be substantially maintained while also tightly packing the ICE. At a high level, the processing can work similar to the technique used in the Wordle data visualization mentioned above. Further information on Wordle is available from Chapter 3 of the book Beautiful Visualization by Jonathan Feinberg which at the time of filing is available publically at http://static.mrfeinberg.com/bv_cho3.pdf. The entire contents of Chapter 3 of Beautiful Visualization are incorporated herein by reference. However, unlike Wordle, the relative layout placement processing also substantially maintains the ordering of the data elements, the processing considers both non-uniform data element sizes and ordering to determine the 2D layout and relationships between each data element, and an ordered anchor point is assigned to each data element. One goal of the processing is to get each data element as close to its anchor point as possible. In one embodiment, the largest data elements are placed first, thus they get their preferred anchor point placement.

The processing that occurs will find the average width and height of the data elements which are going to be laid out and build an ordered grid of anchor points. There will be one anchor point for each data element to be laid out. The processing will determine the best placement for each data element that will allow the data elements to be as close to their anchor points as possible. If any data element is very large, it will skew the placement of the other data elements. However, each data element will still be able to be placed relatively close its desired location. In one embodiment, the data elements will be placed from largest to smallest to ensure that the largest data elements get the optimal locations and the smaller data elements can find space wherever it is available. In the event that the data elements are uniform in size, this approach will produce a nice even grid of data elements because they will all get their preferred location. All of this processing is performed in two dimensional Cartesian coordinates and then converted to spherical coordinates in the spherical layout positioning processing.

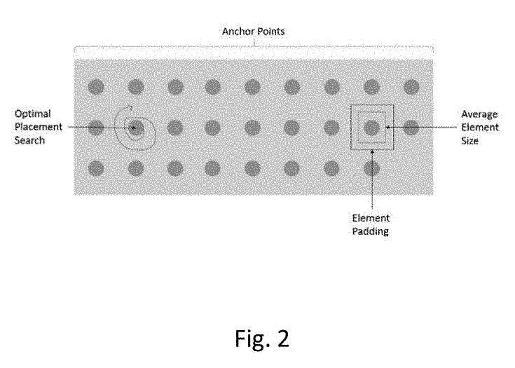

Referring to FIG. 2, the first problem to solve is to determine how many rows and columns will be needed to render the data elements. One challenge in this determination is that a generally rectangular shape for the layout is preferred because the resulting ICE that is generated could potentially use all 360° longitude of the ICE, but typically only 180° latitude at most (and potentially less).

This can be modeled by providing the following ratio:

$${layout}_{ratio} = \frac{c}{r}$$

where c is the number of columns in proportion to r rows. The values c and r are simply used as ratios, so these values can actually represent the angle in degrees that one wishes to use in the longitudinal and latitudinal directions. For example 360/140 can be used to draw a rectangle that will fit over all 360° longitude but only layout at most 140° latitude. Here, 140° is used because putting elements in the resulting ICE directly above or below the user in latitude is difficult to use and gets cluttered at the poles. In one embodiment, the ICE can extend between about 180 degrees to about 360 degrees in longitude about the user. In one embodiment, the ICE can extend no more than about 140 degrees in latitude about the user.

Using values c and r, the total number of rows and columns needed can be solved with the following equations:

$$maxcols = ⌈ c \sqrt{\frac{n}{cr}} ⌉$$

$$maxrows = ⌈ r \sqrt{\frac{n}{cr}} ⌉$$

where n is the number of clusters being rendered in the ICE.

Note that a ceiling function is used to round up each number. Finding the number of max columns and rows will produce a decimal, and the rows and columns should be represented as integers. When rounded up, one may not need all cells represented by the grid of rows and columns, but one can at least be confident that there are enough cells. These values are derived from the assumption that the number of clusters n can be represented as a rectangular area where each side is equal to some value x multiplied by constants r and c. An example of the formula to find x is:

$$cx \times rx = n$$

$$x = \sqrt{\frac{n}{cr}}$$

The value of x can be substituted back into the area equation. The following area equation can then be composed, which can then be used to solve for the maxcols and maxrows:

$$c \sqrt{\frac{n}{cr}} \times r \sqrt{\frac{n}{cr}} = n$$

The average width and height of the data elements is also determined. The following equations can be used to find the padded average width and height of all the data elements provided to the ICE:

$${w}_{avg} = \frac{{Σ}_{c}^{comps} ( {c}_{w} + {p}_{w} )}{n}$$

$${h}_{avg} = \frac{{Σ}_{c}^{comps} ( {c}_{h} + {p}_{h} )}{n}$$

where comps is the set of data elements to layout and p is the two dimensional padding value to pad each data element in the ICE.

The best placement of the data elements can then be determined. Before translating the layout into a 3D spherical shape, the layout must be constructed in 2D. After the grid of anchor points has been laid out, each data element is placed in the order of their individual surface area. If a data element cannot be placed right at its ideal spot (the corresponding anchor) a search technique is used to look for a nearby spot where the data element can fit. The search is done radially by stepping over a search angle, θ, and a search radius, r_{search} to produce a 2D point p which is checked for valid placement:

p=(sin θ*r_{search},cos θ*r_{search})

At the point in which all of the data elements have been laid down, the needed 2D surface area of the entire layout can be computed. The values xₘᵢₙ, xₘₐₓ, yₘᵢₙ and yₘₐₓ can be computed by iterating over all placed elements as follows:

A_{surface}=(xₘₐₓ−xₘᵢₙ)×(yₘₐₓ−yₘᵢₙ)

Spherical Layout Positioning Processing

In the spherical layout positioning processing, a determination is made on how to arrange the data elements in 3D in order to maintain relationships found in the relative layout placement processing. This includes determining the spherical placement of each data element in a quadrangle which is defined as the intersection of longitudinal and latitudinal angles forming a surface on a sphere. In addition, the needed radius of the sphere is determined in order to capture all the data elements provided in the layout.

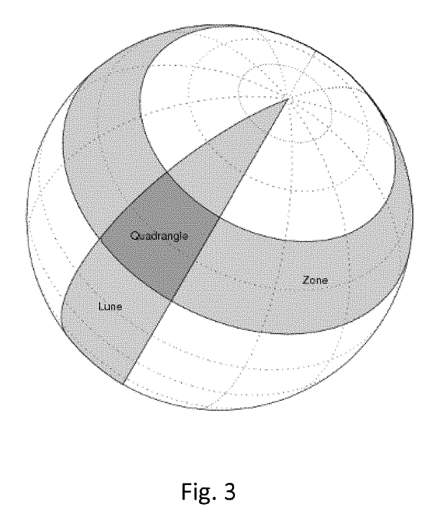

To determine how large the sphere needs to be given the surface area of all the data elements, the calculation needs to consider the needed surface area of the layout and the angles (in degrees) of the allowable area of the sphere that can be rendered. With reference to FIG. 3, this intersection of the allowable angles is called a quadrangle, defined by latitude and longitude.

The following equation can be used to calculate the surface area of a quadrangle:

$${A}_{quadrangle} = \frac{π {r}^{2} \vert sin {θ}_{lat , start} - sin {θ}_{lat , end} \vert \vert {θ}_{lon , end} - {θ}_{lon , start} \vert}{180}$$

This equation can be restructured to find the necessary size of the sphere for defined surface area and spherical limits. Here one can substitute the found surface area of the layout for the area of quadrangle as follows:

$$r = \sqrt{\frac{180 {A}_{surface}}{π \vert sin {θ}_{lat , start} - sin {θ}_{lat , end} \vert \vert {θ}_{lon , end} - {θ}_{lon , start} \vert}}$$

Once the size of the sphere has been determined, one can then determine, in degrees, the rotational height and width of the spherical layout as follows:

$${θ}_{ion}^{′} = \frac{360 {w}_{t}}{2 π r}$$

$${θ}_{lat}^{′} = \frac{360 {h}_{t}}{2 π r}$$

where wₜ and hₜ are the total height and width that are found from the two dimensional layout, computed from the actual consumed surface area. These equations find the ratio of the consumed width and height to the circumference which are then multiplied by 360 degrees to find the angles that are needed in the latitudinal and longitudinal directions.

With the total rotational height and width angles found, one can find the individual latitudinal and longitudinal angles for a given data element. The goal is to center the total 2D layout on angle (0,0,0) and fill the space identified by the supplied latitude and longitude. The following formula can be used to find the centered angular values mapping from 2D to 3D spherical coordinates:

$${θ}_{c , lat} = \frac{{θ}_{lat}^{′} ( {p}_{y} - {y}_{min} )}{{y}_{max} - {y}_{min}} - \frac{{θ}_{lat}^{2}}{2} {θ}_{c , lon} = \frac{{θ}_{lon}^{′} ( {p}_{x} - {x}_{min} )}{{x}_{max} - {x}_{min}} - \frac{{θ}_{lon}^{′}}{2}$$

which can be simplified to:

$${θ}_{c , lat} = \frac{{θ}_{lat}^{′} ( 2 {p}_{y} - {y}_{min} - {y}_{max} )}{2 ( {y}_{max} - {y}_{min} )} {θ}_{c , lon} = \frac{{θ}_{lon}^{′} ( 2 {p}_{x} - {x}_{min} - {x}_{max} )}{2 ( {x}_{max} - {x}_{min} )}$$

where p is the Cartesian coordinate of the element and xₘₐₓ and yₘₐₓ are the 2D boundaries of the Cartesian layout.

In one embodiment, the ICE can extend between about 180 degrees to about 360 degrees in longitude and can extend no more than about 140 degrees in latitude about the user. In one embodiment, the ICE can extend from about −70 degrees to about 70 degrees in latitude, and from at least about −90 degrees to about 90 degrees in longitude.

An example of programming code implementing the relative layout placement processing and the spherical layout positioning processing described above is as follows:

ICE Data Elements Layout

Algorithm CloudLayout(elements, p, min_radius, fov_long, fov_lat)

aw = find average width including padding
ah = find average height including padding
maxrows = determine maximum number of rows needed given fov_long, fov_lat
maxcols = determine maximum number of columns needed given fov_long,
fov_lat
nc = length of elements
// find an anchor for each element fed into the cloud
anchors = [nc]
i = 0 // current index of anchor
for j=0 to maxcols

for k=0 to maxrows and while i < nc

elements[i] = (j * aw, k * ah)

end for

end for
// calculate the data element layout in 2D first
pc = sort elements by largest area // prioritized elements
pa = sort anchors by element
max_x, max_y = (−infinity)
min_x, min_y = (infinity)
placed = [ ]
for i=0 to nc

c = pc[i]
a = pa[i]
Place(c, a, p, placed)
placed[i] = c
// track the max and min layout coordinates
if (c.x − c.width / 2) < min_x

min_x = c.x − c.width / 2

end if
if (c.y − c.height / 2) < min_y

min_y = c.y − c.height / 2

end if
if (c.x + c.width / 2) > max_x

max_x = c.x + c.width / 2

end if
if (c.y + c.height/2) > max_y

max_y = c.y + c.height / 2

end if

end for
// find the necessary surface area to render the 2D elements
sa = compute surface area given max_x, min_x, max_y, min_y
// determine the size of the sphere needed for the elements
r = find minimum radius given the surface area
r = max(r, min_radius) // allow the user to specify a default size
// relate anchor positions, which are relative, to actual spherical coordinates
if using the users supplied min_radius

theta_lon = find spherical layout longitude given r, fov_lon
theta_lat = find spherical layout latitude given r, fov_lat

else

theta_lon = fov_long
theta_lat = fov_lat

end if
for i=0 to nc

c = placed[i]
angle = compute 3D angle given Cartesian coordinates
rotate (c, angle)
translate(c, r)

end for

end

ICE Data Elements Placement

Algorithm Place(element, anchor, padding, placed[ ], a_step_count, r_step_count)

// calculate search parameters
a_step = (PI * 2) / a_step_count
r_step = 0
// iterate over the search space until a placement is found that
// does not overlap other elements
is_overlapping = IsOverlapping(c, element)
int i = 0
while is_overlapping

next_a_step= a_step * i;
p = find next search point given next_a_step, r_step

element.position = p

// check the validity of the new position
is_overlapping = IsOverlapping(c, element)
r_step = r_step + r_step_count
i = i + 1

end while

end

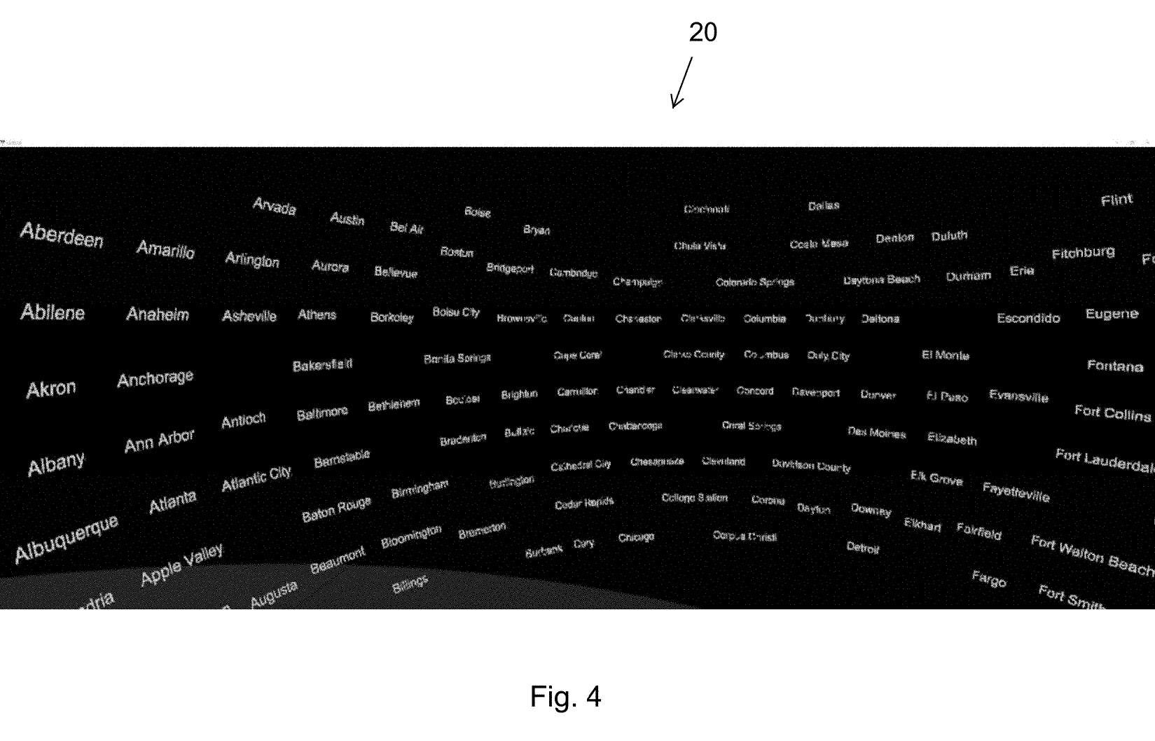

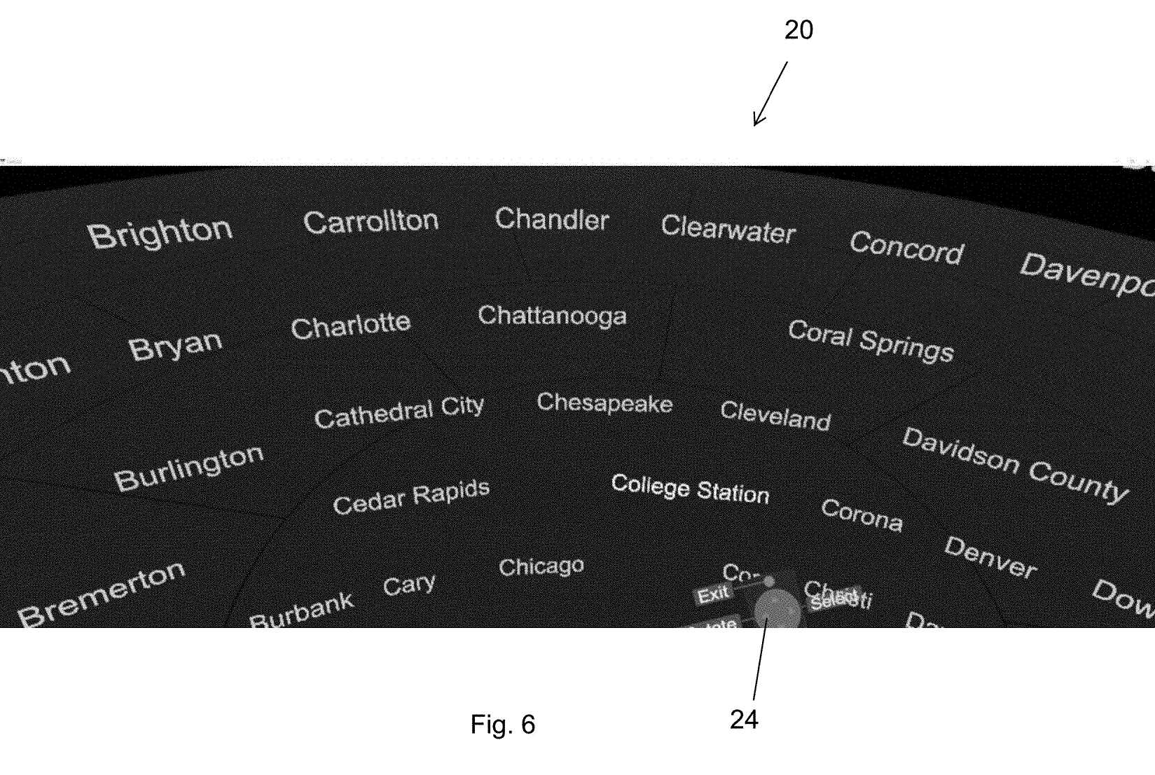

FIGS. 4-6 illustrate an example of a 3D ICE 20 that is generated from the city names in FIGS. 1A-B using the processing described herein and thereafter displayed. As depicted, the city names are laid out generally into a plurality of rows and columns within the quadrangle. As seen in FIGS. 4-6, there is generally a constant distance or space between each row of the city name data elements. However, due to variations in sizes of the data elements, the space between some of the rows may vary. FIG. 4 illustrates a large portion of the ICE 20 that is larger than the Field of View of the user at any one time, while FIG. 6 illustrates a smaller portion of the ICE 20 near the center of the ICE 20 that is in the Field of View of the user at that moment in time.

In one non-limiting embodiment, the 3D ICE in FIGS. 4-6 can have the following parameters:
FOV Latitude: 60 degrees such as −30 to +30; −20 to +40; etc.
FOV Longitude: 180 degrees such as −90 to +90; −60 to +120; etc.
Word Padding (i.e. additional amount of space provided around each data element as depicted in FIG. 2): (0.02 meters, 0.02 meters)
Minimum Radius of curvature: 0.5 meters
Deconfliction Radius Step: 0.0001 meters
Deconfliction Angle Count: 64 (an integer defining the number of angle positions to test in the search algorithm)

Any of the parameters above can be adjusted to get different 3D ICE performance. For example, the minimum radius of curvature can be adjusted if it is determined that the starting radius is too close. Or one or both of the deconfliction parameters can be adjusted to adjust resolution. The smaller the deconfliction radius step, the longer the algorithm will take, but the tighter packed the resulting 3D ICE layout will be.

The Deconfliction Radius Step and Deconfliction Angle Count parameters relate to “r_step_count” and “a_step_count”, respectively, in the programming code above. “r_step_count” and “a_step_count” define how big of a step to take while searching for the optimal placement of each data element. When these parameters are small, the layout placement processing algorithm will have very refined placement, but may take a long time to produce the results. On the contrary, when they are large, the layout placement processing algorithm will run very quickly, but will not have optimal placement. The deconfliction radius step and the deconfliction angle count define the discrete steps taken by the search algorithm. When a tested position is found to be occupied, the algorithm can increase the angle by the deconfliction angle count divided by 360 degrees. When a full rotation is made, the radius of the search algorithm is increased by the deconfliction radius step. The higher these numbers, the faster and less resolute the algorithm will become.

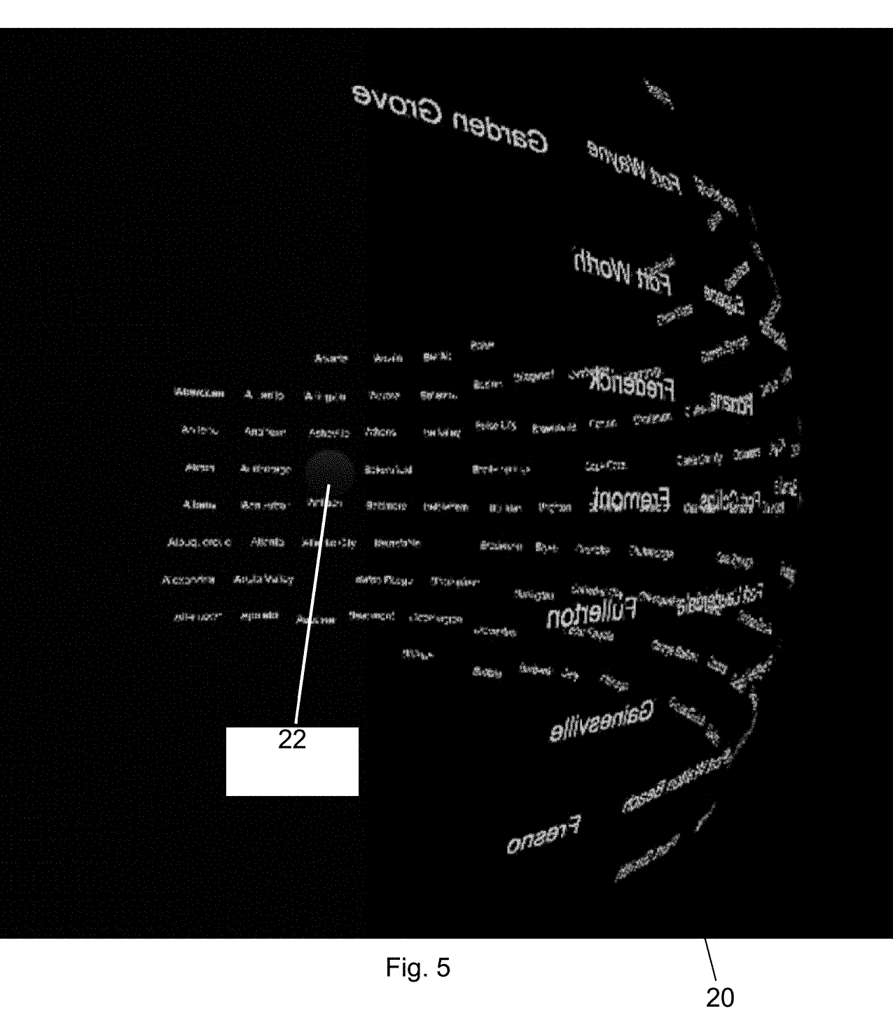

As best seen in FIG. 4, in this embodiment the displayed 3D ICE 20 appears to have a “concave” curvature (from the perspective of the user) so that the user is looking at the concave side of the 3D ICE 20. In another embodiment, it is possible that the displayed 3D ICE 20 could appear to have a “convex” curvature (from the perspective of the user) so that the user is looking at the convex side of the 3D ICE 20. FIG. 5 illustrates an exterior or rear view of the displayed 3D ICE 20 with the user indicated at point 22 showing the displayed 3D ICE 20 wrapped around the user 22.

In FIG. 4, the user can adjust his Field of View by turning his head to the left or right, or up or down to see further city names. Alternatively, the user can use a mechanism such as a remote control 24 (partially visible in FIG. 6) to adjust the user interface left or right, or up or down to change the Field of View. In another embodiment, the user can manually “swipe” the displayed user interface left or right, or up or down, to scroll the user interface in the direction of the swipe.

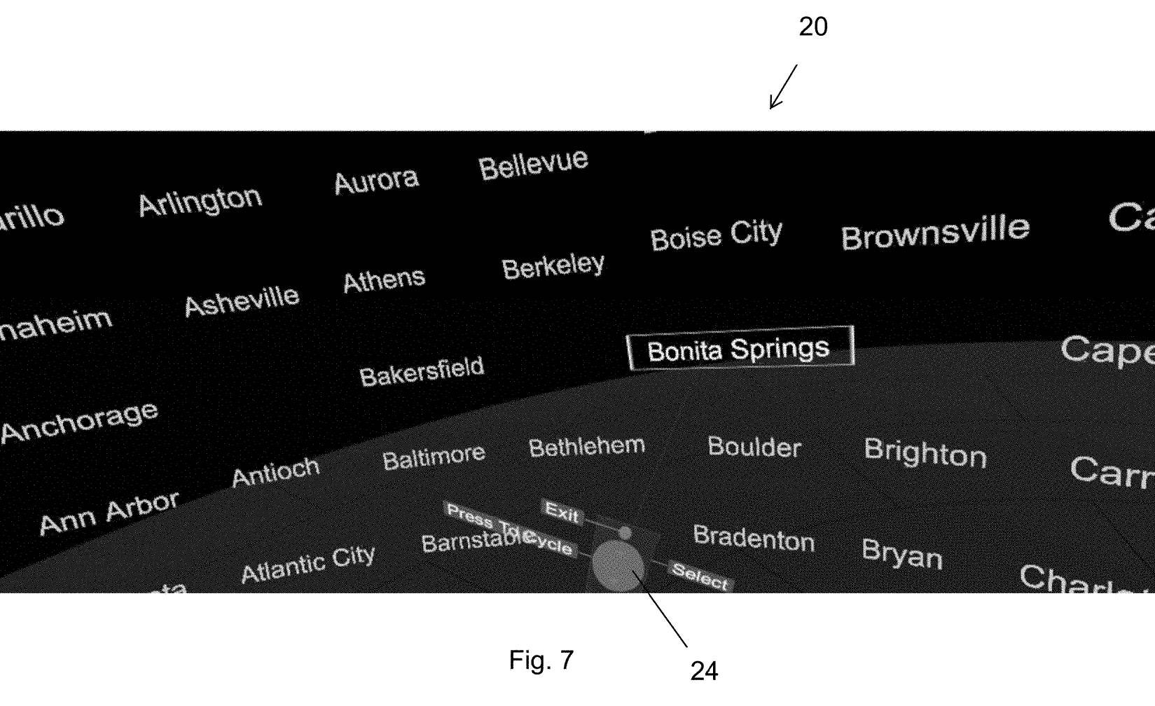

In the displayed 3D ICE 20 of FIGS. 4-6, the user 22 is able to select one of the desired data elements displayed in the 3D ICE 20 which, when selected, will then result in the generation and display of a new user interface with data elements relating to the selected data element. For example, FIG. 7 illustrates the 3D ICE 20 with the city name Bonita Springs being selected by the user for example using the remote control 24. As part of the selection, the selected Bonita Springs data element can be indicated graphically in a suitable manner to visually indicate to the user that it has been selected. For example, the Bonita Springs data element can be outlined and/or the text highlighted. When the Bonita Springs data element is selected, data elements relating to Bonita Springs can be laid out generally into a plurality of rows and columns in a newly generated 3D ICE. In one non-limiting example, data elements relating to Bonita Springs could be businesses in the City of Bonita Springs. If the user selects one of the new data elements in the newly generated 3D ICE, another and different 3D ICE can be generated and displayed with data elements relating to the selected new data element. This can be repeated until the user drills down and locates the desired data.

A data element can be selected in any suitable manner. For example, the user can use a mechanism such as the remote control 24 (see FIGS. 6 and 7) to control the position of a cursor or other indicator to select the desired data element. Selection may also be made by the user using his eyes, where movement of the user's eyes is tracked. Selection may also be made manually by the user where the 3D ICE is displayed in a manually interactive manner that permits the user to “touch select” the desired data element using his finger or hand.

The 3D ICE can be displayed using any type of 3D display application. For example, in one embodiment, the 3D ICE can be displayed to the user on a head mounted display (for a VR display) or on an optical head mounted display (for an AR display) that is worn by the user. In another embodiment, the 3D ICE can be displayed to the user via a 3D holographic projection. In another embodiment, the 3D ICE can be displayed in a Cave Automatic Virtual Environment (CAVE), or the 3D ICE could be displayed on other surround-screen displays. The 3D ICE could also be displayed via smartphone and tablet augmented reality. In some embodiments, the 3D ICE can also be displayed using 2D displays such as standard or touch screen monitors.

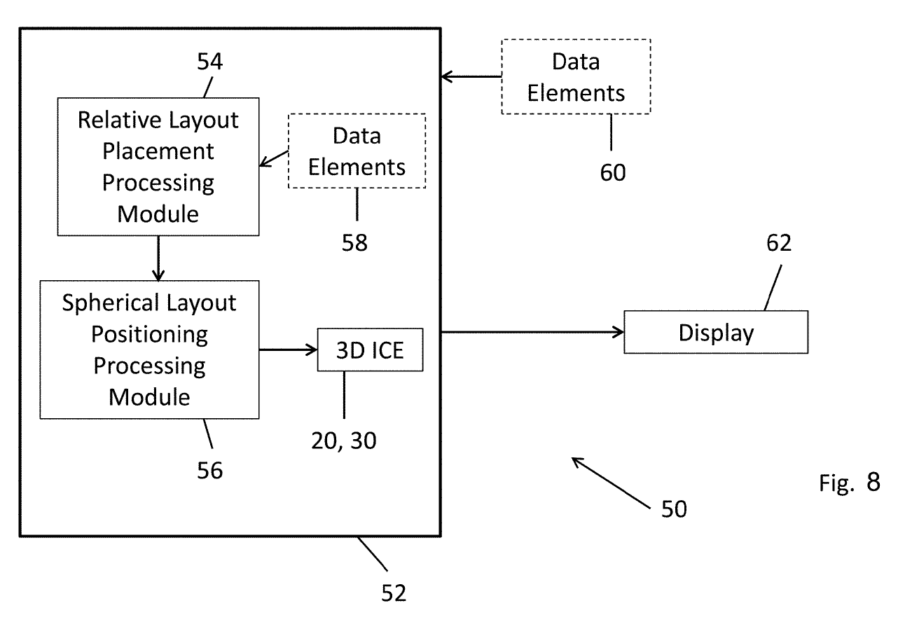

Referring to FIG. 8, a system 50 for generating and displaying the 3D ICE described herein is illustrated. The system 50 includes one or more computers 52 configured to implement the relative layout placement processing and the spherical layout positioning processing described herein. In one embodiment, the relative layout placement processing can be performed by a Relative Layout Placement Processing Module 54 that can be programmed to perform the relative layout placement processing described herein, while the spherical layout positioning processing can be performed by a Spherical Layout Positioning Processing Module 56 that can be programmed to perform the spherical layout positioning processing described herein. The relative layout placement processing by the module 54 can be performed prior to the spherical layout positioning processing by the module 56 which receives the processed data from the module 54. The data elements for generating the 3D ICE 20 can be supplied to the Relative Layout Placement Processing Module 54 and/or to the Spherical Layout Positioning Processing Module 56 from one or more suitable data storage locations 58 of the computer 52 and/or from one or more external data storage locations 60 external to the computer 52.

The resulting generated 3D ICE 20 is output from the computer 52 for display on a suitable display 62, for example on a head mounted display (for a VR display), on an optical head mounted display (for AR display), or projected to the user as a 3D holographic projection.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A data visualization method of displaying discrete data elements to an end user, comprising:
generating a three-dimensional immersive cloud environment of the discrete data elements using one or more computers, the three-dimensional immersive cloud environment including a relative layout placement of the discrete data elements and a spherical layout positioning of the discrete data elements; and
displaying the generated three-dimensional immersive cloud environment to the end user, wherein the discrete data elements in the displayed three-dimensional immersive cloud environment do not overlap one another, wherein the end user is able to select any one of the discrete data elements in the displayed three-dimensional immersive cloud environment whereby when one of the discrete data elements in the displayed three-dimensional immersive cloud environment is selected additional data related to the selected one of the discrete data elements is displayed.

2. The data visualization method of claim 1, wherein the relative layout placement of the discrete data elements is determined prior to determining the spherical layout positioning of the discrete data elements.

3. The data visualization method of claim 1, wherein at least some of the discrete data elements in the displayed three-dimensional immersive cloud environment have different sizes compared to other ones of the discrete data elements in the displayed three-dimensional immersive cloud environment.

4. The data visualization method of claim 1, wherein the discrete data elements have an ordering, and the ordering of the discrete data elements in the displayed three-dimensional immersive cloud environment is substantially maintained.

5. The data visualization method of claim 4, wherein the ordering is alphabetical.

6. The data visualization method of claim 1, wherein the displayed three-dimensional immersive cloud environment extends between about 180 degrees to about 360 degrees in longitude and extends no more than about 140 degrees in latitude.

7. The data visualization method of claim 1, wherein the discrete data elements comprise alphabetical text, numeric text, alphanumeric text, images, symbols, or combinations thereof.

8. The data visualization method of claim 1, wherein displaying the three-dimensional immersive cloud environment to the end user comprising displaying the three-dimensional immersive cloud environment on a head mounted display worn by the user.

9. The data visualization method of claim 1, wherein the relative layout placement of the discrete data elements comprises arranging the discrete data elements into a plurality of rows and columns.

10. A method, comprising:
using one or more computers to generate a three-dimensional immersive cloud environment from a plurality of discrete, rectangular user interface elements that have a pre-determined ordering by determining a relative layout placement of the rectangular user interface elements followed by determining a spherical layout positioning of the rectangular user interface elements, the relative layout placement of the rectangular user interface elements includes arranging the rectangular user interface elements into a plurality of rows and columns; and
displaying the generated three-dimensional immersive cloud environment to an end user, wherein the ordering of the rectangular user interface elements in the displayed three-dimensional immersive cloud environment is substantially maintained, wherein the rectangular user interface elements in the displayed three-dimensional immersive cloud environment are displayed in the rows and columns and the rectangular user interface elements do not overlap one another, wherein at least some of the rectangular user interface elements in the displayed three-dimensional immersive cloud environment have different sizes compared to other ones of the rectangular user interface elements in the displayed three-dimensional immersive cloud environment, and wherein the end user is able to select any one of the rectangular user interface elements in the displayed three-dimensional immersive cloud environment whereby when one of the rectangular user interface elements in the displayed three-dimensional immersive cloud environment is selected additional data related to the selected one of the rectangular user interface elements is displayed.

11. The method of claim 10, wherein the displayed three-dimensional immersive cloud environment extends between about 180 degrees to about 360 degrees in longitude and extends no more than about 140 degrees in latitude.

12. The method of claim 10, wherein the rectangular user interface elements comprise alphabetical text, numeric text, alphanumeric text, images, symbols, or combinations thereof.

13. The method of claim 10, wherein displaying the generated three-dimensional immersive cloud environment to the end user comprising displaying the generated three-dimensional immersive cloud environment on a head mounted display worn by the user.

14. The method of claim 10, wherein the ordering of the rectangular user interface elements is alphabetical.
